(19) United States
(12) Patent Application Publication
(10) Pub. No.: US 2026/0244501 A1
(43) Pub. Date: Aug. 20, 2026

(54) RESOURCE RECOMMENDATION

(71) Applicant: DevRev, Inc., Palo Alto, CA (US)

(72) Inventors: Matic Conradi, Celje (SI); Matjaž Finžgar, Ljubljana (SI); Dragoslav Radin, Ljubljana (SI); Svit Zebec, Ljubljana (SI)

(73) Assignee: DevRev, Inc., Palo Alto, CA (US)

(21) Appl. No.: 19/059,013

(22) Filed: Feb. 20, 2025

(51) Int. Cl. G06F 9/50; G06F 9/451

(52) U.S. Cl. CPC G06F 9/5027; G06F 9/452; G06F 9/5077

(57) ABSTRACT

Techniques for identification and recommendation of resources are provided. A resource interaction record is obtained based on an entity profile descriptor indicating attributes linked with an entity. Resource identifiers from this record are used to transmit interaction signals to accessed resources, for receiving response payloads in return. The operational status of each resource is determined from these payloads. Based on the operational status, a payload evaluation workflow may be triggered, executing a computational model to evaluate contextual similarity between response payloads and resource information assets linked to candidate resources. The model identifies candidate resources with logical relationships to resources accessed by the entity. A recommendation generation signal is then generated for indicating the candidate resources identified for the entity.

### BACKGROUND

In the modern digital landscape, entities, for example, individuals and organizations interact with multiple resources. These resources may include, for example, websites, web applications, cloud services, databases, business tools, and various other software and digital platforms. The patterns of interaction between the entities and these resources can provide valuable insights into the entity's interests, needs, and potential future resource requirements. However, existing approaches struggle to effectively utilize these interactions and often result in imprecise or outdated evaluations, leading to inefficient resource requirement assessments and missed opportunities for meaningful digital engagement.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates a block diagram of a system, according to one example implementation of the present subject matter.

FIG. 2 illustrates a computing environment comprising the system, according to one example implementation of the present subject matter.

FIG. 3 illustrates an exemplary method for identification and recommendation of resources, according to one example implementation of the present subject matter.

FIG. 4 illustrates a non-transitory computer-readable medium for recommending one or more resources, according to one example implementation of the present subject matter.

Throughout the drawings, identical reference numbers designate similar, but not necessarily identical, elements. The figures are not necessarily scaled, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In today's interconnected digital landscape, entities such as individuals, organizations, and automated systems interact with diverse resources. These resources may encompass a wide spectrum of digital assets, including but not limited to websites, web applications, software applications, cloud-based services, databases, analytical tools, and various other platforms and services that provide specific functionalities or information. The interactions, and patterns of such interactions, between the entities and the resources can provide valuable insights into the entity's interests, technical capabilities, and intelligence about potential future resource requirements.

Generally, attempts to understand behavior of entities and predict future resource needs have relied heavily on static demographic data or broad categorizations of users or entities based on limited criteria. Such conventional solutions often employ simplistic heuristics or rule-based solutions that guess probable future resource needs or requirements. As a result, they frequently produce imprecise or outdated assessments, leading to inefficient assessments of resource requirement and missed opportunities for meaningful digital engagement.

Further, such solutions fail to capture the actual and/or dynamic entity-resource interactions in modern digital ecosystems and lead to inaccurate guesses about an entity's true interests or needs. The existing approaches typically lack the ability to dynamically adapt to changing entity behaviors or to consider the actual interactions between entities and resources. Such limitations result in static profiles that may not reflect updated or true entity needs or interests, potentially leading to misaligned resource recommendations or ineffective resource provisioning. Another significant challenge is the inability to effectively correlate an entity's interactions across multiple, diverse resources. Without this holistic view, it becomes difficult to identify resources accessed by an entity. It also limits the ability to recognize patterns or relationships between different types of resources that an entity accesses. This, in turn, restricts the ability to make informed predictions about other potentially relevant resources.

The limitations of existing approaches further extend to the realm of contextual analysis. For example, lack of the capability to derive the semantic context from entity-resource interactions results in a one-dimensional view of entity behavior, missing crucial nuances that could lead to more diverse and accurate resource recommendations. Additionally, current solutions often fail to account for the dynamic nature of resources themselves. For example, web services and digital platforms frequently undergo changes, updates, or deprecations. Without a robust mechanism to evaluate the operational status, such solutions may base their analyses on outdated or irrelevant data points, leading to recommendations of, for example, non-operational resources. Thus, limitations of the existing solutions prevent sophisticated and data-driven analysis of entity-resource interactions and confidently determine possible resource requirements.

The present subject matter discloses techniques for identification and recommendation of resources. In one example, the present subject matter also discloses rendering of the recommendation of resources. In one example operation, an entity profile descriptor indicating one or more attributes linked with an entity may be received. Examples of the entity may include, but are not limited to, individual users or customers, organizations, and automated systems or software. Further, the attributes may be any information, detail, or biography about the entity. For example, the attributes may help in identifying the entity and/or indicate one or more characteristics about the entity. Examples of the attributes may include, but are not limited to, name of entity, contact details, details of people associated with the entity, operational details, marketing materials or data, products and/or services offered, websites of the entity, and domain names associated with the entity.

In response to receiving the entity profile descriptor, a resource interaction record mapping with the entity profile descriptor may be obtained. In one example, the resource interaction record may be Domain Name System (DNS) records indicating one or more resource identifiers linked with a set of resources accessed by the entity. The resource identifiers, in one example, may be Uniform Resource Locators (URLs) or Uniform Resource Identifiers (URIs), indicating a digital address or identifiers of the resources accessed by the entity.

Further, a resource interaction signal may be transmitted to each resource in the set of resources based on the one or more resource identifiers. In one example, the resource interaction signal may be a GET request or an Hypertext Transfer Protocol (HTTP) request that may be transmitted to resource identifier associated with each resource in the set of resources. The resource interaction signal may be transmitted to receive, in response, a response payload for each resource in the set of resources. That is, a resource interaction signal may be transmitted to one or more resource identifiers linked with each resource in the set of resources, in order to receive a response payload from each resource identifier linked with each resource in the set of resources. In one example, the response payload may be a GET response or HTTP response to the GET request or the HTTP request.

The response payload may indicate, for example, status information about the resource identifier and/or the resource linked with that resource identifier. Based on the response payload, an operational status of each resource in set of resources may be identified. For example, based on the status information, it may be determined whether the resource has a positive or negative status. Based on the operational status of each resource in the set of resources, it may be ascertained whether to trigger a payload evaluation workflow for each resource in the set of resources. For example, if it is determined that the operational status of a resource is negative (for example, inactive or non-operational status), the payload evaluation workflow may not be required to be triggered. However, if it is determined that the operational status of a resource is positive (for example, active or operational status), it may be ascertained that the payload evaluation workflow may be triggered.

In one example, triggering the payload evaluation workflow may cause execution of a computational model to evaluate a contextual similarity between the response payload, received for each resource in the set of resources, and a resource information asset. In one example, the resource information asset may indicate one or more characteristics linked with a plurality of candidate resources. In one example, the candidate resources may be a curated collection of resources intended for digital engagement, distribution, recommendation, promotion, or access by the entity.

Triggering the payload evaluation workflow may further cause identification of one or more candidate resources from amongst the plurality of candidate resources based on the evaluated contextual similarity. For example, the candidate resources that are determined to have resource information assets semantically similar to the response payload, may be identified. Thus, such one or more candidate resources may be, for example, resources that the entity, based on their resource interaction record, may probably be interested in for utilization or digital engagement. For example, if the entity has frequently accessed certain types of resources (for example, a specific tool), these patterns may indicate a higher probability of interest in similar resources (i.e., candidate resources) for future use or engagement. Further, a recommendation generation signal may be generated to indicate the one or more candidate resources identified for the entity. In one example, the recommendation generation signal may be a command that may cause rendering of a graphical user interface to indicate the one or more candidate resources identified for the entity.

The present subject matter addresses the problems related to resource recommendation and entity behavior analysis. By recommending candidate resources based on the resource interaction record, the recommendation of candidate resources may be derived based on the resources that were actually accessed by the entity, potentially overcoming limitations associated with static profiling methods. This approach may allow for more accurate, true, and up-to-date assessments of entity needs and interests, which may lead to improved accuracy in resource recommendations. By leveraging actual interaction data rather than relying solely on demographic information or broad categorizations, more precise and relevant resource suggestions may be generated. This data-driven approach may lead to higher engagement rates and improved user experiences.

Further, in one example, it may also be possible that the recommendations may be dynamically adapted according to the changing interactions of the entity with the resources, capturing updated interactions between entities and resources. This adaptability may result in a more nuanced understanding of entity preferences and requirements. By focusing on actual usage patterns and interactions, the present subject matter may offer a more robust and flexible solution compared to conventional methods. This approach may be particularly beneficial in rapidly evolving digital ecosystems where needs and available resources are constantly changing. The ability to adapt and provide relevant resource recommendations based on real or actual interactions may lead to improved entity or user satisfaction. Further, the approach described in the present subject matter may facilitate a more sophisticated and data-driven analysis of entity-resource interactions. This may enable more confident determination of resource requirements and enhance overall digital engagement strategies. For example, valuable insights into entity interests may be leveraged for various purposes such as personalized marketing, product development, or service improvements. For entities or users, the improved accuracy of resource recommendations may lead to a more satisfying and productive digital experience, as they are more likely to be presented with relevant and useful resources. The data-driven approach may enable the creation of more accurate and dynamic entity profiles based on actual interactions, potentially leading to improved personalization of resource recommendations.

Further, the resource interaction record may provide insights into the diverse range of resources accessed by the entity, potentially offering a comprehensive view of entity-resource interactions. This holistic perspective may broaden the scope of candidate resources that could potentially align with the entity's interests or requirements. The ability to evaluate contextual or semantic similarity may further enhance the resource recommendation process. This approach may capture a multi-dimensional view of entity behavior and candidate resources by considering concepts, resemblance, meaning, and potential overlap between them, and may uncover semantic relevance and connections that may not be apparent through simpler keyword-based or rule-based systems. The present subject matter may thus allow for more nuanced and contextually relevant resource recommendations, potentially identifying candidate resources that might otherwise be overlooked. By leveraging these advanced analytical techniques, more tailored and diverse recommendations may be offered that closely align with the entity's actual needs and interests.

Further, the operational status verification feature may ensure that recommendations are based on current, functional resources. By checking the operational status of resources before analysis, the likelihood of recommending outdated or non-operational resources is reduced, reducing false positives and improving the overall quality of recommendations. The operational status verification may also serve as a filtering mechanism, potentially saving computational resources by avoiding unnecessary analysis of non-operational or outdated resources. This approach may lead to more efficient processing and may help maintain the relevance and reliability of the resource recommendations provided to the entity.

Thus, the present subject matter offers a sophisticated resource recommendation solution that addresses multiple technical challenges in digital ecosystems. By leveraging actual usage data, operational status verification, and advanced computational models, enhanced recommendation accuracy and relevance may be achieved. The solution's adaptability ensures that recommendations remain current as entity behaviors and resource statuses change. Further, by incorporating contextual similarity analysis and operational status checks, the likelihood of recommending irrelevant or non-functional resources may be significantly reduced. The approach enables more precise entity profiling based on actual interactions, leading to highly personalized resource suggestions. These technical advantages collectively result in a more efficient, accurate, and adaptable resource recommendation solution that can effectively identify and suggest appropriate resources across various platforms, potentially improving entity engagement and resource utilization in complex digital landscapes.

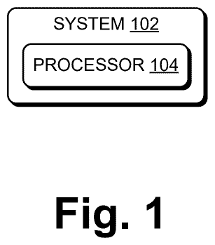

The above techniques are further described with reference to FIGS. 1 to 4. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a block diagram of a system 102, according to one example implementation of the present subject matter. In one example, the system 102 may be capable of identifying and recommending one or more resources.

In one example, the system 102 may comprise a processor 104. The processor 104, in one example operation, may obtain, in response to receiving an entity profile descriptor indicating one or more attributes linked with an entity, a resource interaction record based on the entity profile descriptor. In one example, the resource interaction record may indicate one or more resource identifiers linked with a set of resources accessed by the entity. Based on the one or more resource identifiers, the processor 104 may transmit a resource interaction signal to each resource, in the set of resources, to receive, in response, a resource payload for each resource in the set of resources. Based on the response payload, the processor 104 may determine an operational status of each resource in the set of resources.

Further, the processor 104 may ascertain, based on the operational status of each resource in the set of resources, whether to trigger a payload evaluation workflow for each resource in the set of resources. In one example, triggering of the payload evaluation workflow may cause execution of a computational model to evaluate a contextual similarity between the response payload, received for each resource in the set of resources, and a resource information asset. In one example, the resource information asset may indicate one or more characteristics linked with each of a plurality of candidate resources. Based on the evaluated contextual similarity, the payload evaluation workflow may cause identification of one or more candidate resources. The candidate resources may have a logical relationship with one or more resources from amongst the set of resources, accessed by the entity. Further, the processor 104 may generate a recommendation generation signal to indicate the one or more candidate resources identified for the entity.

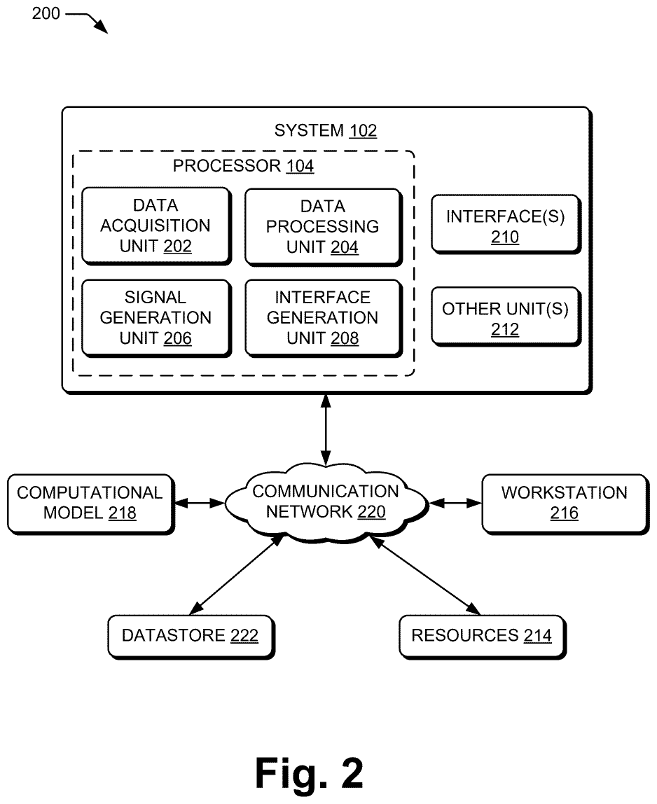

FIG. 2 illustrates a computing environment 200 comprising the system 102, according to one example implementation of the present subject matter.

In one example, the computing environment 200 may be any environment comprising at least the system 102, where the system 102 may be capable of, and/or may be utilized for, recommending one or more resources with respect to an entity. In one example, the recommendation may be based on assessment of resource interaction records, as will be discussed. Further, in one example, the system 102 may also be capable of causing generation of a graphical user interface to render the recommendation of the one or more resources for an entity, as will be discussed.

In one example, the system 102 may be implemented in the computing environment 200 as a set of one or more hardware devices or modules. For example, the system 102 may be implemented as a set of one or more hardware devices, comprising at least a processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions.

In another example, the system 102 may be implemented as a set of computer-executable instructions. In this example, the processor 104 may be an engine capable of executing the set of computer-executable instructions for recommending one or more resources for an entity. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer-executable instructions may be executed by the processor 104 for recommending one or more resources for the entity.

In one example, the processor 104 may comprise one or more sub-processing units or engines. For example, the processor 104 may comprise a data acquisition unit 202, a data processing unit 204, a signal generation unit 206, and an interface generation unit 208. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory of other unit(s) 212 of the system 102. In other examples, the units or engines may be implemented as electronic circuitry.

The system 102 may further comprise, in one example, interface(s) 210. The interface(s) 210 may include a variety of software and hardware interfaces that allow interaction of the system 102 with other communication and computing devices, such as network entities, web servers, external repositories, and peripheral devices, such as input/output (I/O) devices. For example, the interface(s) 210 may communicably couple the system 102 with at least one of resources 214, a workstation 216, a computational model 218, a communication network 220, and a datastore 222 to exchange data and/or signals. The interface(s) 210 may also enable the coupling of internal components of the system 102 with each other.

The system 102 may further comprise, in one example, the other unit(s) 212. The other unit(s) 212 may include, in one example, a power supply unit, a communication unit, and the memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with at least one of the resources 214, the workstation 216, the computational model 218, the communication network 220, and a datastore 222 to exchange data and/or signals. Also, the communication unit may allow the system 102 to transmit and receive data, files, and/or signals.

Further, the memory may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 104.

Further, the computing environment, in one example, may comprise a plurality of resources 214. Examples of the resource 214 may include, but are not limited to, websites, web applications, software applications, cloud-based services, databases, analytical tools, mobile apps, machine learning models, blockchain platforms, digital libraries, collaboration tools, cybersecurity tools, data visualization software, customer relationship management (CRM) systems, enterprise resource planning (ERP) systems, network devices/resources, and various other products, platforms, and services that provide specific functionalities or information. Other examples of the resources 214 may include, but are not limited to, word processors, spreadsheets, presentation software, database management software, web browsers, email clients, graphic design software, project management tools, finance-related applications, social media applications or platforms, content delivery application or platform.

In one example, each resource may have at least one resource identifier linked therewith. The resource identifier may be any information that may be capable of identifying the resource linked therewith. Examples of the resource identifiers may include, but are not limited to, URLs, URIs, host names, domain names, and any digital identifier or address linked with the resource. Thus, each of the resources 214 may have one or more resource identifiers linked therewith. Further, the resources 214 may be accessible, either directly or through the communication network 220, to the system 102, the computational model 218, the workstation 216, and the datastore 222. In another example, only the resource identifiers associated with each of the resources 214 may be accessible to the system 102, the computational model 218, the workstation 216, and the datastore 222. In this example, a mapping between the resource identifiers and their corresponding resources 214 may be stored in the datastore 222 accessible to at least one of the system 102, the computational model 218, and the workstation 216.

In one example, the computing environment 200 may include the workstation 216. In some examples, the workstation 216 may be a software-based application or tool capable of allowing or enabling access to the resources 214. For example, the workstation 216 may be a software, application, one or more web pages, a web browser, or a cloud-based platform that may enable a user to access the resources 214. Similarly, other examples of the workstation 216 may also be possible. In some instances, the workstation 216 may be a hardware-based system or device. Examples of such workstation 216 may include, but are not limited to, a computing system or a desktop, a mobile, and a laptop. In one example, the hardware-based system or device may be capable of allowing or enabling access to the resources 214. The access may be provided directly or through the above-discussed software-based application or tools. For example, such a workstation 216, in one example, may execute or allow access to the above-discussed software-based applications or tools, that may be accessed by a user, for accessing or utilizing the resources 214.

Further, in one example, the workstation 216 may comprise a display device and an input mechanism. The input mechanism may be, for example, a keyboard, mouse, or even a touch input received on the display device of the workstation 216. In one example, the display device may be capable of rendering graphical user interface(s). The graphical user interface may be, for example, an interactive interface with which the user may be able to interact and view different information, for example, related to the resources 214. Further, the user may also be able to submit queries and view, interact, modify, and customize the information being rendered via the display device and the input mechanism associated with the workstation 216. For example, the user may be able to submit details about an entity, through the workstation 216, for which resource recommendation is to be generated. For example, the workstation 216 may render a graphical user interface that may enable or allow the user to submit queries, such as details about the entity for which resource recommendation(s) is to be generated.

In one example, the computing environment 200 may comprise the datastore 222. The datastore 222 may include, for example, a set of storage devices capable of storing data and information. The set of storage devices may be virtual storage devices, physical storage devices, a cloud-based storage service, or a combination thereof. For example, the datastore 222 may be any repository or storage unit implemented by physical, logical, and/or virtual storage devices. In one example, the datastore 222 may include a set of physical storage devices. In another example, the datastore 222 may include virtual storage devices being implemented on physical storage devices. In another example, the datastore 222 may include one or more physical or logical storage units that may either be located at the same location or distributed geographically. In another example, the datastore 222 may be implemented over a cloud-based storage service. Further, the datastore 222 may be a single data store or a combination of two or more datastores.

The datastore 222 may be capable of, for example, storing data related to, or generated by, at least one of the resources 214, the workstation 216, and the computational model 218. For example, the datastore 222 may store the mapping between the resource identifiers and their corresponding resources 214. In one example, the datastore 222 may also store the details about the entity, such as entity profile descriptor, received from the user, for instance, through the workstation 216. In one example, the datastore 222 may also comprise or store data indicating the resources 214 accessed by different entities. Examples of the entity may include, but are not limited to, one or more users, organizations, software or applications, or any automated systems.

In one example, the datastore 222 may be, or may comprise, one or more servers or network devices that may store resource interaction records indicating the one or more resource identifiers, linked with the resources 214, accessed different entities. The server(s) or network devices(s) may be, for example, devices associated with an Internet Service Provider (ISP) and may log or record details indicating the resources 214 accessed by different entities. That is, the datastore 222 may store a history, log, or record linked with each of the entities. Such history, log, or record may be identifiable or searchable with details about the entities. The details, herein after referred to as entity details, may include, but are not limited to, name of entity, contact details, details of people associated with the entity, operational details, marketing materials or data, products and/or services offered, websites of the entity, and domain names associated with the entity.

Further, in one example, the resource interaction record may be Domain Name System (DNS) records indicating one or more resource identifiers linked with the resources 214. The resource identifiers may be, for example, Uniform Resource Locators (URLs) or Uniform Resource Identifiers (URIs), indicating a digital address or identifiers of each of the resources 214. Thus, the datastore 222 may store data, such as the resource interaction records, indicating the resources 214 accessed by one or more entities.

In one example, the computing environment 200 may comprise the computation model 218. The computational model 218 may be implemented as a set of algorithms, mathematical equations, or statistical methods designed to process input data and generate outputs or predictions. In another example, the computational model 218 may be implemented on a hardware device having stored thereon the set of algorithms, mathematical equations, or statistical methods. In some aspects, the computational model 218 may be based on machine learning techniques, such as neural networks, decision trees, support vector machines, or deep learning architectures. For example, the computational model 218 may be a Large Language Model (LLM), a Natural Language Processing (NLP) model, or a Generative Pre-training Transformer (GPT) model. The computational model 218 may be used for various purposes within the computing environment 200, such as data analysis, contextual analysis, semantic similarity analysis, and the like. For example, the computational model 218 may assist in performing the payload evaluation workflow, as will be discussed. In some implementations, the computational model 218 may further include mechanisms for explainability or interpretability, providing reasoning behind its outputs or decisions. Further, in some aspects, the computational model 218 may be customizable or configurable, allowing it to be adapted for different use cases or domains within the computing environment 200. Such flexibility may enable the model to be applied to a wide range of applications.

Further, the system 102, or at least the processor 104, may be communicably coupled with at least one of the workstation 216, the resources 214, the datastore 222, and the computational model 218. In one example, the communicable connection may be direct through either wired or wireless means and may enable the exchange of data and/or signals therebetween. In another example, the communicable connection may be through the communication network 220 to exchange data and/or signals. Examples of the communication network 220 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 220 may include various network entities, such as transceivers, gateways, and routers. In an example, the communication network 220 may include any communication network that uses any of the commonly used protocols, for example, Hypertext Transfer Protocol (HTTP), and Transmission Control Protocol/Internet Protocol (TCP/IP).

Thus, the computing environment 200 illustrates an example of an environment having different entities or components that may be communicably coupled with each other. Further, FIG. 2 illustrates that the system 102 may be communicably coupled with at least one of the resources 214, the workstation 216, the computational model 218, and the datastore 222 through the communication network 220. However, other implementations may also be possible. For example, the system 102 may only be communicably coupled with the datastore 222 or the workstation 216. In another example, the system 102 may comprise the processor 104 and at least one of the datastore 222, the computation model 218, and the workstation 216, and such system 102 may be communicably coupled with the resources 214. Similarly, different architectures may also be possible, though not illustrated.

In one example operation of the present subject matter, the processor 104, or the data acquisition unit 202, may obtain a resource interaction record mapping with an entity profile descriptor. In one example, the resource interaction record may be obtained in response to receiving the entity profile descriptor indicating one or more attributes linked with an entity. The entity profile descriptor may be received, for example, by the processor 104 from a user wishing to generate resource recommendations with respect to the entity. In one example, the entity profile descriptor may be received by the processor 104 through the workstation 216. For example, the workstation 216 may be a device or a software-based application or tool, as discussed above, and may allow the user to submit the entity profile descriptor for the entity. Similarly, an entity profile descriptor can be received by the processor 104 from other sources as well. For example, the entity profile descriptor may be received from an organization wishing to generate resource recommendations for the entity. In another example, the entity profile descriptor linked with the entity may be stored in the datastore 222 and be received from the datastore 222.

In one example, the entity profile descriptor may be information about the entity, and may indicate one or more attributes linked with the entity. The attributes may be any information, detail, or biography about the entity that may assist or enable identification of the entity and/or indicate one or more characteristics or properties of the entity. Examples of the attributes may include, but are not limited to, name of the entity, contact details, details of people associated with the entity, operational details, marketing materials or data, products and/or services offered, websites of the entity, and domain names associated with the entity. Thus, the entity profile descriptor can be a wide spectrum of information that can at least indicate or identify the entity. Further, in one example, the entity profile descriptor may be in a textual or machine-readable format. In one example, the empirical entity descriptor may include structured data fields such as JSON or XML formats. For example, an entity profile descriptor for an organization might include {“name”, “industry”: “Software”, “location”: “San Francisco, CA”, “primaryDomain” (for example, web address with “. com”),“technicalFocus”: [“cloud computing”, “AI”, “data analytics”]}. Thus, the entity profile descriptor can be a wide spectrum of information that can at least indicate or describe an entity.

In response to receiving the entity profile descriptor, the processor 104 may obtain the resource interaction record mapping with the entity profile descriptor. In one example, the resource interaction record may be Domain Name System (DNS) records indicating one or more resource identifiers linked with a set of resources, from amongst the resource 214, accessed by the entity. The resource identifiers, in one example, may be links, hyperlinks, Uniform Resource Locators (URLs) or Uniform Resource Identifiers (URIs), indicating a digital address or identifier of the set of resources accessed by the entity. The set of resources may include one or more of the resources 214.

In one example, the resource interaction record may be obtained from the datastore 222 that may store, or may comprise a server(s) or network device(s) that may store, history, logs, or records indicating the resources 214 accessed by different entities, as discussed above. The datastore 222 may maintain a time-stamped log of resource interactions for each entity. In one example, recent interactions may be weighted more heavily.

Further, in one example, the datastore 222 may be queried with the entity profile descriptor to identify the resource interaction records for the entity based on the details (described as the entity profile descriptor) provided for the entity. For example, the entity details linked with different entities, as discussed above, may be compared with the entity profile descriptor to identify an entity detail that matches with the entity profile descriptor. In one example, the processor 104, or the data processing unit 204, may query the datastore 222 to identify the entity detail matching with the entity profile descriptor. For example, if the entity profile descriptor indicates name of an entity as XYZ corporation, the entity details matching with the name may be identified. In another example, the processor 104 may trigger the computational model 218 to identify the entity detail that semantically maps with the entity profile descriptor. The entity linked with the matching entity detail may be accordingly identified and the resource interaction record of that entity may be obtained from the datastore 222.

Further, the processor 104, or the signal generation unit 206, may transmit or send a resource interaction signal to each resource in the set of resources based on the one or more resource identifiers. As discussed above, the resource interaction record may indicate the one or more resource identifiers linked with each resource in the set of resources, accessed by the entity. The processor 104 may transmit a resource interaction signal to each resource based on the one or more resource identifiers linked therewith. In one example, the resource interaction signal may be a GET request or an Hypertext Transfer Protocol (HTTP) request that may be transmitted to each of the one or more resource identifiers associated with each resource in the set of resources.

The resource interaction signal may be transmitted to receive, in response, a response payload for each resource in the set of resources. That is, a resource interaction signal may be transmitted to one or more resource identifiers linked with each resource in the set of resources, in order to receive a response payload from each resource identifier linked with each resource in the set of resources. For example, the GET request may be sent to the resource identifier to request data from the resource linked with that resource identifier. For example, a GET request may be sent to a URL (i.e., a resource identifier) linked with a web service (i.e., a resource). In one example, the data or acknowledgement received, in response to the GET request or HTTP request, may be a GET response or HTTP response, and may be referred to as the response payload. Further, in addition, or alternatively, to GET and HTTP requests, the processor 104, in one example, may send specialized Application Programming Interface (API) calls, WebSocket connections, or custom protocols depending on the resource type. For example, for a database resource, the interaction signal may be a Structured Query Language (SQL) query.

Further, the response payload may indicate, for example, status information about the resource identifier and/or the resource linked with that resource identifier. For example, the response payload may include a status line or status code indicating an operational status of the resource linked with that resource identifier. The status line or status code may be any conventionally known information. Examples of such status line or status codes may include, but are not limited to, code 200 (indicating that the resource has operational status), code 404 (indicating resource not found using that resource identifier, thereby indicating that the resource may probably not be in operational status or the resource identifier may be faulty), and code 500 (indicating server or resource error, thereby indicating the resource may probably not be in operational status). Similarly, there may be different types of codes or other information received in the response payload, which may be analysed or processed by the processor 104 or the data processing unit 204 to determine an operational status of each resource in the set of resources. In one example, the processor 104 may also take the assistance of the computational model 218 to analyze or process the response payload and determine the operational status.

In one example, the response payload may also indicate a response time indicating a time taken by the resource to respond to the resource interaction signal, indicating any existing performance issues with the resource. Based on such response time, the operational status of the resource could also be determined. In one example, the response payload may also indicate details or metadata about the resource from which it may be received. Examples of such details may include, but are not limited to, name of the resource, functionality details, host name, and/or domain name associated with the resource. In another example, in addition or alternative to the above factors, the processor 104 may determine operational status based on validation of content (for example, checking for expected data structures) of the response payload. Thus, the processor 104 may employ a multi-factor approach to determine operational status.

Based on the response payload, the processor 104 may thus determine the operational status of each resource in the set of resources. For example, the operational status may be either a positive or negative status. The positive status may represent that the response payload indicates that the resource has an operational status or is functional. Whereas, the negative status may represent that the resource may probably have a non-operational status or may be non-functional.

Based on the operational status of each resource in the set of resources, the processor 104 or the data processing unit 204 may ascertain whether to trigger a payload evaluation workflow for each resource in the set of resources. For example, if the processor 104 determines that the operational status of a resource is negative (for example, inactive or non-operational status), the payload evaluation workflow may not be required to be triggered. However, if the processor 104 determines that the operational status of a resource is positive (for example, active or operational status), the processor 104 may ascertain that the payload evaluation workflow may be triggered.

Based on the operational status of each resource in the set of resources, the processor 104 may thus ascertain to trigger the payload evaluation workflow. In one example, triggering the payload evaluation workflow may cause execution of the computational model 218 to evaluate a contextual similarity between the response payload, received for each resource in the set of resources, and a resource information asset. In one example, the resource information asset may indicate one or more characteristics linked with a plurality of candidate resources. In one example, the candidate resources may be a curated collection of resources intended for digital engagement, distribution, recommendation, promotion, or access by the entity for which the resource interaction record was obtained. In one example, the candidate resources may be resources other than the set of resources accessed by the entity. For example, the candidate resources may be alternative resources having similar functionalities and features like the set of resources. Further, examples of the characteristics may include, but are not limited to, name of the candidate resource, functionality details, host name of candidate resource, and/or domain name associated with the candidate resource. The resource information asset may thus be any descriptive data about the candidate resources. In one example, the resource information asset may be obtained from the user, as a prompt to the processor 104 or the computational model 218, through the workstation 216.

In one example, triggering the payload evaluation workflow may further cause execution of the computational model 218. In one example, the processor 104 may execute the computation model 218 to implement the payload evaluation workflow. The computational model 218, in one example, evaluate a contextual similarity between the response payload, received for each resource in the set of resources, and the resource information asset. As discussed above, the response payload may indicate details or metadata about the resource from which it may be received. In another example, where the response payload may not include such details or metadata, such data may be queried and obtained from the datastore 222. In one example, the datastore 222 may comprise comprehensive information, details, or metadata about the resources 214. Such information, details, or metadata may also be a part of the response payload for the purpose of payload evaluation workflow. That is, the resources from which the response payload was received, the information, details, or metadata about such resources may be added to the response payload upon ascertaining that the payload evaluation workflow is to be triggered, and may thus be a part of the response payload. Further, the processor 104 or the computational model 218 could also obtain such information, details, or metadata about the resources from other sources, for example, the internet or any other comprehensive database about the resources.

Further, the computational model 218 may evaluate a contextual similarity between the response payload, received for each resource in the set of resources, and the resource information asset. In one example, the contextual similarity may indicate a semantic similarity between the response payload, received for each resource in the set of resources, and the resource information asset. In one example, to evaluate the semantic similarity, the processor 104 may cause the computational model 218 to compute a similarity score. The similarity score may quantitatively indicate the semantic similarity between the response payload, received for each resource in the set of resources, and the resource information asset linked with each candidate resource from amongst the candidate resources.

In one example, the computational model 218 may encode the response payload and the resource information asset into a response vector and a resource vector, respectively. For example, the computational model 218 may transform words, phrases, or entire response payload into numerical representation. One approach may be to use frequency-based representations, where text is encoded based on how often words or tokens appear. Each word may be assigned a value reflecting its occurrence within the response payload, creating a straightforward representation of text. Another method may focus on capturing the context in which words appear. Contextual representations encode the meaning of a word by analyzing its surrounding words in the response payload. This approach may ensure that words with similar meanings or usage patterns are represented by similar vectors, enhancing the understanding of semantic relationships. In yet another example, statistical relationships between words, such as their co-occurrence patterns, can also be used to generate vectors. Words frequently appearing together or in similar contexts are positioned closer to each other in the vector space. In yet another example, predefined embeddings, developed using large datasets, provide another approach. These embeddings may assign pre-trained vectors to words, capturing nuanced semantic and syntactic details without the need for extensive training on specific tasks. Similarly, the resource information asset linked with each candidate resource may be encoded into vectors, referred to as the resource vectors.

The computational model 218, to evaluate the contextual or semantic similarity, may compare the response vector and the resource vector, derived for resource information asset linked with each of the candidate resources. Based on the comparison of the vectors, the computational model 218 may compute the similarity score for each such comparison. The similarity score may be computed using any known method. For example, the similarity score may be based on the distance between two vectors. A smaller distance may imply greater semantic similarity. In another example, similarity score may be computed based on measures of cosine of the angle between two vectors. The closer the cosine value is to 1, the more similar the vectors are. Similarly, different techniques may be used to compute the similarity score between two vectors. Thus, for each possible combination of a response vector with a resource vector, a similarity score may be determined. For example, consider that the set of resources includes two resources and there are two candidate resources. Each resource may have a response vector (derived based on the response vector linked with that resource) linked therewith and each candidate resource may have a resource vector (derived based on the resource information asset linked with that candidate resource). In such a case, the similarity score may be determined for each combination of a response vector with a resource vector.

In another example, the computational model 218 may use any other know technique for contextual similarity evaluation. For example, for text-based resources, techniques like TF-IDF (Term Frequency-Inverse Document Frequency) or cosine similarity of word embeddings may be used. For image-based resources, techniques like SIFT (Scale-Invariant Feature Transform) or deep learning-based image embeddings may be used.

The computational model 218 or the processor 104 may then identify one or more candidate resources from amongst the plurality of candidate resources based on the evaluated contextual similarity. For example, the identification of the one or more candidate resources from amongst the plurality of candidate resources may be based on the similarity score. In one example, the computational model 218 or the processor 104 may compare the similarity score with a threshold similarity score to identify the one or more candidate resources, having the resource information asset semantically conforming with the response payload received for each resource in the set of resources. For example, the similarity score linked with each combination of response vector and resource vector may be compared with the threshold similarity score. In one example, the threshold similarity score may be pre-defined by the user through the workstation 216, or any platform or software accessible to the user. If the processor 104 or the computational model 218 determines that the similarity score, determined a pair of response vector and resource vector, is equal to or greater than the threshold similarity score, the processor 104 or the computational model 218 may identify such combinations to be semantically conforming or similar. Thus, the response payload and the resource information asset linked with such response vector and resource vector may be determined to be contextually or semantically similar. However, if the processor 104 or the computational model 218 determines that the similarity score, determined for each combination, is less than the threshold similarity score, the processor 104 or the computational model 218 may identify such combination to be contextually or semantically non-conforming.

Similarly, there may be other possible techniques also that may be used for the selection of the candidate resources. In one example, resources with similarity scores above the mean may be selected as candidate resources. In another example, percentile-based cutoff (e.g., top 10% of similarity scores) may be used for selection or identification of the candidate resources.

Thus, the processor 104 or the computational model 218, based on the comparison, may identify the one or more candidate resources that may be similar to the resources in the set of resources. The contextual or semantic similarity may thus indicate that the one or more candidate resources may have a logical relationship with one or more resources from amongst the set of resources accessed by the entity. For example, the one or more candidate resources may have similar or enhanced functionalities as compared to the one or more resources from amongst the set of resources accessed by the entity. Such one or more candidate resources may be, for example, resources that the entity, based on their resource interaction record, may probably be interested in for utilization or digital engagement. For example, if the entity has frequently accessed certain types of resources (for example, a specific tool), these patterns may indicate a higher probability of interest in similar resources (i.e., candidate resources).

Further, the processor 104 or the signal generation unit 206 may then generate a recommendation generation signal to indicate the one or more candidate resources identified for the entity. In one example, the recommendation generation signal may be a command generated by the processor 104 to cause rendering of a graphical user interface to indicate the one or more candidate resources identified for the entity. In one example, the graphical user interface may render or display the one or more identified candidate resources. The graphical user interface, in one example, may be rendered on the display device of the workstation 216 to intuitively and in a user-friendly manner indicate the one or more identified candidate resources being recommended for the entity. In one example, the resource information asset, or at least a portion thereof, linked with such candidate resources may also be displayed for convenient identification of the candidate resources or for indicating additional insights or information about such candidate resources.

However, other techniques for generating recommendations may also be used. For example, the generation of the recommendation generation signal may cause the generation of JSON API responses for integration with other systems or interfaces, email digests with personalized resource recommendations, push notifications on an application, or an interactive dashboard with resource exploration features.

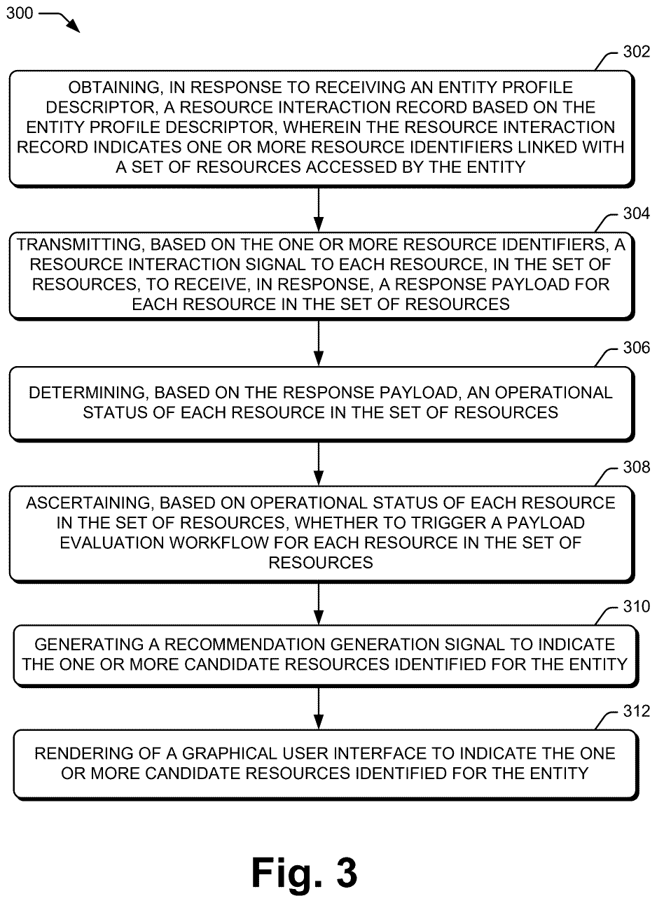

FIG. 3 illustrates an exemplary method 300 for identification and recommendation of resources, according to one example implementation of the present subject matter. The order in which the method is described is not intended to be construed as a limitation, and any number of the described method blocks may be combined in any order to implement the method 300, or an alternative method. Furthermore, the method 300 may be implemented by processing resource or computing device(s) through any suitable hardware, non-transitory machine-readable instructions, or combination thereof.

It may also be understood that the method 300 may be performed by programmed computing devices, such as the processor 104, as depicted in FIGS. 1 and 2. Furthermore, the method 300 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 300 is described below with reference to the processor 104 and the system 102 as described above; other suitable systems for the execution of these methods may also be utilized. Additionally, the implementation of these methods is not limited to such examples. Further, FIG. 3 will be discussed in conjunction with FIGS. 1 and 2 for the sake of brevity and the description of FIGS. 1 and 2 shall be incorporated herein for reference.

At block 302, a resource interaction record may be obtained based on an entity profile descriptor. In one example, the resource interaction record may be obtained in response to receiving the entity profile descriptor indicating one or more attributes linked with an entity, as discussed above. In one example, the entity profile descriptor may include textual information about the entity, where the information may indicate one or more attributes linked with the entity. The attributes may be any information, detail, or biography about the entity that may identify the entity and/or indicate one or more characteristics or properties of the entity, as discussed above.

In response to receiving the entity profile descriptor, the resource interaction record may be obtained based on the entity profile descriptor. In one example, the resource interaction record may be Domain Name System (DNS) records indicating one or more resource identifiers linked with a set of resources, from amongst the resource 214, accessed by the entity. The resource identifiers, in one example, may be links, hyperlinks, Uniform Resource Locators (URLs) or Uniform Resource Identifiers (URIs), indicating a digital address or identifier of the set of resources accessed by the entity.

In one example, the resource interaction record may be obtained from the datastore 222. In one example, the datastore 222 may be queried with the entity profile descriptor to identify the resource interaction records for the entity, as discussed above.

At block 304, a resource interaction signal may be transmitted to each resource in the set of resources, based on the one or more resource identifiers. As discussed above, the resource interaction record may indicate the one or more resource identifiers linked with each resource in the set of resources, accessed by the entity. The resource interaction signal may be transmitted or sent to each resource based on the one or more resource identifiers linked therewith. In one example, the resource interaction signal may be a GET request or an HTTP request that may be transmitted to each of the one or more resource identifiers associated with each resource in the set of resources. In one example, the resource interaction signal may be transmitted to receive, in response, a response payload for each resource in the set of resources. That is, a resource interaction signal may be transmitted to one or more resource identifiers linked with each resource in the set of resources, in order to receive a response payload from each resource identifier linked with each resource in the set of resources, as discussed above. In one example, the response payload may be data or acknowledgement received, in response to the GET request or HTTP request. For example, the response payload may be a GET response or HTTP response, and may be referred to as the response payload.

Further, as discussed above, the response payload may indicate, in one example, status information about the resource identifier and/or the resource linked with that resource identifier. In one example, the response payload may also indicate details or metadata about the resource from which it may be received, and may be referred to as the response payload. Examples of such details may include, but are not limited to, name of the resource, functionality details, host name, and/or domain name associated with the resource.

At block 306, the operational status of each resource in the set of resources may be determined based on the response payload received for each resource in the set of resources, as discussed above.

At block 308, it may be ascertained, based on the operational status of each resource in the set of resources, whether a payload evaluation workflow is to be triggered for each resource in the set of resources. For example, if a resource and/or a resource identifier linked with that resource is determined to have negative operational status, as discussed above, it may be ascertained that the payload evaluation workflow is not to be triggered. However, if a resource and/or a resource identifier linked with that resource is determined to have a positive operational status, as discussed above, it may be ascertained that the payload evaluation workflow is to be triggered.

In one example, triggering the payload evaluation workflow may cause execution of the computational model 218 to evaluate a contextual similarity between the response payload, received for each resource in the set of resources, and a resource information asset. In one example, the resource information asset may indicate one or more characteristics linked with each of a plurality of candidate resources, as discussed above. In one example, the candidate resources may be a curated collection of resources intended for digital engagement, distribution, recommendation, promotion, or access by the entity for which the resource interaction record was obtained.

Further, the computational model 218, in one example, may evaluate a contextual similarity between the response payload, received for each resource in the set of resources, and the resource information asset linked with each candidate resource from amongst the plurality of candidate resources. As discussed above, the response payload may indicate details or metadata about the resource from which it may be received. In another example, where the response payload may not include such details or metadata, such data may be queried and obtained from the datastore 222. In one example, the datastore 222 may comprise comprehensive information, details, or metadata about the resources 214. Such information, details, or metadata may also be a part of the response payload for the purpose of payload evaluation workflow. That is, the resources from which the response payload was received, the information, details, or metadata about such resources may be added to the response payload upon ascertaining that the payload evaluation workflow is to be triggered, and may thus be a part of the response payload. Further, the processor 104 or the computational model 218 could also obtain such information, details, or metadata about the resources from other sources, for example, the internet or any other comprehensive database about the resources 214.

Further, the computational model 218 may evaluate the contextual similarity between the response payload, received for each resource in the set of resources, and the resource information asset linked with each candidate resource from amongst the plurality of candidate resources. In one example, the contextual similarity may indicate a semantic similarity between the response payload, received for each resource in the set of resources, and the resource information asset linked with each candidate resource from amongst the plurality of candidate resources. In one example, to evaluate the semantic similarity, the computational model 218 may compute the similarity score, as discussed above, for each combination or pair of the response vector and the resource vector. The similarity score may quantitatively indicate the semantic similarity between the response payload, received for each resource in the set of resources, and the resource information asset linked with each candidate resource from amongst the candidate resources.

Further, one or more candidate resources from amongst the plurality of candidate resources may then be identified based on the evaluated contextual similarity. For example, the identification of the one or more candidate resources from amongst the plurality of candidate resources may be based on the similarity score, as discussed above.

At block 310, a recommendation generation signal may be generated to indicate the one or more candidate resources identified for the entity. In one example, the recommendation generation signal may be a command generated to cause rendering of a graphical user interface to indicate the one or more candidate resources identified for the entity.

At block 312, a graphical user interface may be rendered to indicate the one or more candidate resources identified for the entity. In one example, the graphical user interface may render or display the one or more identified candidate resources. The graphical user interface, in one example, may be rendered on the display device of the workstation 216 to intuitively indicate the one or more identified candidate resources being recommended for the entity. Thus, the candidate resources being recommended for digital engagement, distribution, or promotion for the entity may be displayed on the graphical user interface.

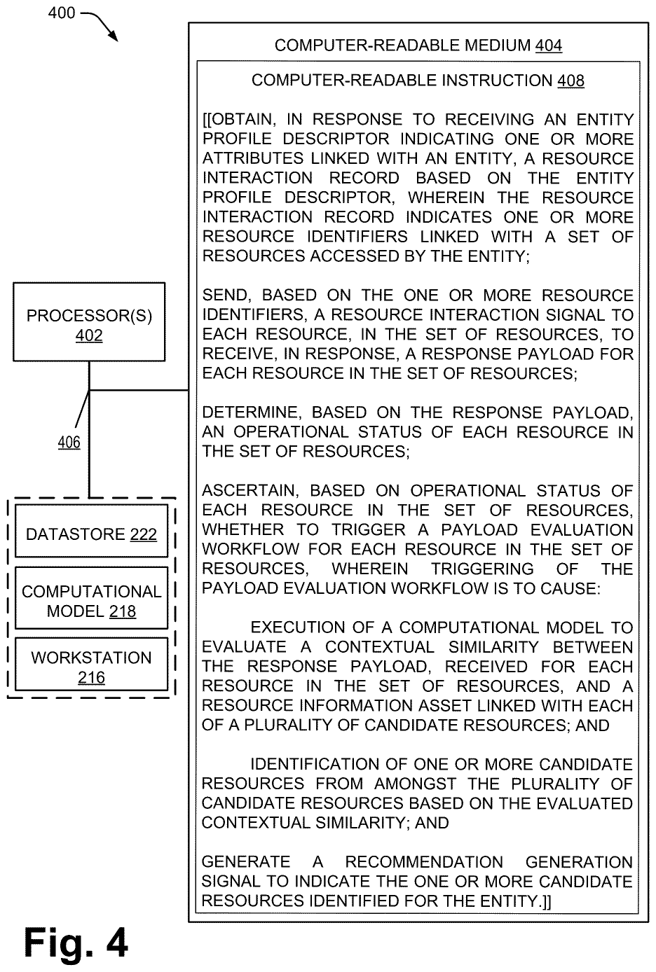

FIG. 4 illustrates a non-transitory computer-readable medium for recommending one or more resources, according to one example implementation of the present subject matter. FIG. 4 will be discussed in conjunction with FIGS. 1 to 3, and the description of FIGS. 1 to 3 shall be incorporated herein for reference and for the sake of brevity.

In an example, the computing environment 400 may comprise a processor 402 communicatively coupled to a non-transitory computer-readable medium 404 through communication link 406. In an example, the processor 402 may have one or more processing resources for fetching and executing computer-readable instructions from the non-transitory computer-readable medium 404. The processor 402 and the non-transitory computer-readable medium 404 may be implemented, for example, in the system 102.

The non-transitory computer-readable medium 404 may be, for example, an internal memory device or an external memory. In an example implementation, the communication link 406 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 404 includes a set of computer-readable instructions 408 which may be accessed by the processor 402 through the communication link 406. The processor 402 and the non-transitory computer-readable medium 404 may also be communicatively coupled to at least one of the datastore 222, the computational model 218, and the workstation 216, as illustrated.

Referring to FIG. 4, in an example, the non-transitory computer-readable medium 404 includes computer-readable instructions 408 that may cause the processor 402 to obtain a resource interaction record based on an entity profile descriptor. In one example, the processor 402 may obtain the resource interaction record in response to receiving the entity profile descriptor indicating one or more attributes linked with an entity, as discussed above.

In an example, the non-transitory computer-readable medium 404 includes computer-readable instructions 408 that may cause the processor 402 to send a resource interaction signal to each resource in the set of resources, based on the one or more resource identifiers. As discussed above, the resource interaction signal may be sent to each resource based on the one or more resource identifiers linked therewith. In one example, the resource interaction signal may be transmitted to receive, in response, a response payload for each resource in the set of resources. In one example, the response payload may be data or acknowledgement received, in response to the GET request or HTTP request. For example, the response payload may be a GET response or HTTP response, and may be referred to as the response payload. Further, as discussed above, the response payload may indicate, in one example, status information about the resource identifier and/or the resource linked with that resource identifier. In one example, the response payload may also indicate details or metadata about the resource from which it may be received, and may be referred to as the response payload.

Further, in an example, the non-transitory computer-readable medium 404 includes computer-readable instructions 408 that may cause the processor 402 to determine the operational status of each resource in the set of resources based on the response payload received for each resource in the set of resources, as discussed above.

Further, in an example, the non-transitory computer-readable medium 404 includes computer-readable instructions 408 that may cause the processor 402 to ascertain, based on the operational status of each resource in the set of resources, whether a payload evaluation workflow is to be triggered for each resource in the set of resources. For example, if a resource and/or a resource identifier linked with that resource is determined to have negative operational status, as discussed above, the processor 402 may ascertain that the payload evaluation workflow is not to be triggered. However, if a resource and/or a resource identifier linked with that resource is determined to have a positive operational status, as discussed above, the processor 402 may ascertain that the payload evaluation workflow is to be triggered.

In one example, triggering the payload evaluation workflow may cause execution of the computational model 218 to evaluate a contextual similarity between the response payload, received for each resource in the set of resources, and a resource information asset linked with each of a plurality of candidate resources. In one example, the resource information asset may indicate one or more characteristics linked with each of the plurality of candidate resources, as discussed above.

The computational model 218 may evaluate a contextual similarity between the response payload, received for each resource in the set of resources, and the resource information asset linked with each candidate resource from amongst the plurality of candidate resources. As discussed above, the response payload may indicate details or metadata about the resource from which it may be received. In another example, where the response payload may not include such details or metadata, such data may be queried and obtained from the datastore 222. In one example, the datastore 222 may comprise comprehensive information, details, or metadata about the resources 214. Such information, details, or metadata may also be a part of the response payload for the purpose of payload evaluation workflow. That is, the resources from which the response payload was received, the information, details, or metadata about such resources may be added to the response payload upon ascertaining that the payload evaluation workflow is to be triggered, and may thus be a part of the response payload. Further, the processor 402 or the computational model 218 could also obtain such information, details, or metadata about the resources from other sources, for example, the internet or any other comprehensive database about the resources 214.

Further, the computational model 218 may evaluate the contextual similarity between the response payload, received for each resource in the set of resources, and the resource information asset linked with each candidate resource from amongst the plurality of candidate resources. In one example, the contextual similarity may indicate a semantic similarity between the response payload, received for each resource in the set of resources, and the resource information asset linked with each candidate resource from amongst the plurality of candidate resources. In one example, to evaluate the semantic similarity, the computational model 218 may compute the similarity score, as discussed above, for each combination or pair of the response vector and the resource vector. The processor 402 or the computational model 218 may then identify one or more candidate resources from amongst the plurality of candidate resources based on the evaluated contextual similarity. For example, the identification of the one or more candidate resources from amongst the plurality of candidate resources may be based on the similarity score, as discussed above.

Further, in an example, the non-transitory computer-readable medium 404 includes computer-readable instructions 408 that may cause the processor 402 to generate a recommendation generation signal to indicate the one or more candidate resources identified for the entity. In one example, the recommendation generation signal may be a command generated for causing rendering of a graphical user interface to indicate the one or more candidate resources identified for the entity. By generating the recommendation generation signal, the processor 402 may cause rendering of the graphical user interface to indicate the one or more candidate resources identified for the entity. The graphical user interface, in one example, may be rendered on the display device of the workstation 216 to intuitively indicate the one or more identified candidate resources being recommended for the entity. Thus, the candidate resources being recommended for digital engagement, distribution, or promotion for the entity may be indicated.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
obtain, in response to receiving an entity profile descriptor indicating one or more attributes linked with an entity, a resource interaction record based on the entity profile descriptor, wherein the resource interaction record indicates one or more resource identifiers linked with a set of resources accessed by the entity;
transmit, based on the one or more resource identifiers, a resource interaction signal to each resource, in the set of resources, to receive, in response, a response payload for each resource in the set of resources;
determine, based on the response payload, an operational status of each resource in the set of resources;
ascertain, based on operational status of each resource in the set of resources, whether to trigger a payload evaluation workflow for each resource in the set of resources, wherein triggering of the payload evaluation workflow is to cause:
execution of a computational model to evaluate a contextual similarity between the response payload, received for each resource in the set of resources, and a resource information asset linked with each of a plurality of candidate resources, wherein the resource information asset indicates one or more characteristics linked with each of the plurality of candidate resources; and
identification of one or more candidate resources from amongst the plurality of candidate resources based on the evaluated contextual similarity, wherein the one or more candidate resources have a logical relationship with one or more resources, from amongst the set of resources, accessed by the entity; and
generate a recommendation generation signal to indicate the one or more candidate resources identified for the entity.

2. The system of claim 1, wherein the generation of the recommendation generation signal is to cause rendering of a graphical user interface to indicate the one or more candidate resources identified for the entity.

3. The system of claim 1, wherein the contextual similarity indicates a semantic similarity between the response payload, received for each resource in the set of resources, and the resource information asset linked with each of the plurality of candidate resources.

4. The system of claim 3, wherein, to evaluate the semantic similarity, the processor is to cause the computational model to compute a similarity score, the similarity score quantitatively indicating the semantic similarity between the response payload, received for each resource in the set of resources, and the resource information asset linked with each of the plurality of candidate resources.

5. The system of claim 4, wherein the identification of the one or more candidate resources from amongst the plurality of candidate resources is based on the similarity score.

6. A method comprising:
obtaining, in response to receiving an entity profile descriptor indicating one or more attributes linked with an entity, a resource interaction record based on the entity profile descriptor, wherein the resource interaction record indicates one or more resource identifiers linked with a set of resources accessed by the entity;
transmitting, based on the one or more resource identifiers, a resource interaction signal to each resource, in the set of resources, to receive, in response, a response payload for each resource in the set of resources;
determining, based on the response payload, an operational status of each resource in the set of resources;
ascertaining, based on operational status of each resource in the set of resources, whether to trigger a payload evaluation workflow for each resource in the set of resources, wherein triggering of the payload evaluation workflow is to cause:
execution of a computational model to evaluate a contextual similarity between the response payload, received for each resource in the set of resources, and a resource information asset linked with each of a plurality of candidate resources, wherein the resource information asset indicates one or more characteristics linked with each of the plurality of candidate resources; and
identification of one or more candidate resources from amongst the plurality of candidate resources based on the evaluated contextual similarity, wherein the one or more candidate resources have a logical relationship with one or more resources, from amongst the set of resources, accessed by the entity; and
generating a recommendation generation signal to indicate the one or more candidate resources identified for the entity.

7. The method of claim 6, wherein the method further comprises rendering of a graphical user interface to indicate the one or more candidate resources identified for the entity.

8. The method of claim 6, wherein the contextual similarity indicates a semantic similarity between the response payload, received for each resource in the set of resources, and the resource information asset linked with each of the plurality of candidate resources.

9. The method of claim 8, wherein, to evaluate the semantic similarity, the method further comprises causing the computational model to compute a similarity score, the similarity score quantitatively indicating the semantic similarity between the response payload, received for each resource in the set of resources, and the resource information asset linked with each of the plurality of candidate resources.

10. The method of claim 9, wherein the identification of the one or more candidate resources from amongst the plurality of candidate resources is based on the similarity score.

11. The method of claim 6, wherein the operational status of each resource, in the set of resources, indicates whether that resource is operational.

12. A non-transitory computer-readable medium comprising instructions, the instructions being executable by a processing resource to:
obtain, in response to receiving an entity profile descriptor indicating one or more attributes linked with an entity, a resource interaction record mapping with the entity profile descriptor, wherein the resource interaction record indicates one or more resource identifiers linked with a set of resources accessed by the entity;
send, based on the one or more resource identifiers, a resource interaction signal to each resource, in the set of resources, to receive, in response, a response payload for each resource in the set of resources;
determine, based on the response payload, an operational status of each resource in the set of resources;
ascertain, based on operational status of each resource in the set of resources, whether to trigger a payload evaluation workflow for each resource in the set of resources, wherein triggering of the payload evaluation workflow is to cause:
execution of a computational model to evaluate a contextual similarity between the response payload, received for each resource in the set of resources, and a resource information asset linked with each of a plurality of candidate resources, wherein the resource information asset indicates one or more characteristics linked with each of the plurality of candidate resources; and
identification of one or more candidate resources from amongst the plurality of candidate resources based on the evaluated contextual similarity, wherein the one or more candidate resources have a logical relationship with one or more resources, from amongst the set of resources, accessed by the entity; and
generate a recommendation generation signal to indicate the one or more candidate resources identified for the entity.

13. The non-transitory computer-readable medium of claim 12, the instructions being executable by the processing resource to cause rendering of a graphical user interface to indicate the one or more candidate resources identified for the entity.

14. The non-transitory computer-readable medium of claim 12, wherein the contextual similarity indicates a semantic similarity between the response payload, received for each resource in the set of resources, and the resource information asset linked with each of the plurality of candidate resources.

15. The non-transitory computer-readable medium of claim 14, wherein, to evaluate the semantic similarity, the processing resource is to cause the computational model to compute a similarity score, the similarity score quantitatively indicating the semantic similarity between the response payload, received for each resource in the set of resources, and the resource information asset linked with each of the plurality of candidate resources.

16. The non-transitory computer-readable medium of claim 12, wherein the identification of the one or more candidate resources from amongst the plurality of candidate resources is based on the similarity score.
